(19) United States
(12) Patent Application Publication
(10) Pub. No.: US 2006/0110537 A1
(43) Pub. Date: May 25, 2006

(54) Anti-fingerprint coating construction

(75) Inventors: Chuan-De Huang, Tu-Cheng (TW); Wei-Hsiang Weng, Tu-Cheng (TW); Wen-Jeng Hwang, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Chengn City (TW)

(21) Appl. No.: 11/285,696

(22) Filed: Nov. 21, 2005

(30) Foreign Application Priority Data
Nov. 23, 2004 (CN) 200410052444.6

(51) Int. Cl. B05D 3/00

(52) U.S. Cl. 427/299

(57) ABSTRACT

An anti-fingerprint coating construction (23) for application to a surface of a substrate (21) includes a layer formed of a material selected from the group consisting of a hydrophobic nano-composite material, an oleophobic nano-composite material, and a super-amphiphobic nano-composite material. When the anti-fingerprint coating construction is employed on a metal surface or a nonmetal surface, sweat or/and grease on fingers of a user is not liable to be adhered to the surface. Therefore a fingerprint of the user is prevented from being imprinted on the surface, and the surface can remain clean and aesthetically pleasing. Because the anti-fingerprint coating construction is easy to clean, the anti-fingerprint coating construction has good anti-corrosion and antibacterial properties. The anti-fingerprint coating construction contains no chromium, and therefore does not need to be processed by an acid or alkali solution. This makes the anti-fingerprint coating construction environmentally friendly.

### BACKGROUND OF THE INVENTION

The present invention relates to an anti-fingerprint coating construction for use in applications such as an enclosure of an electronic apparatus.

With the rapid development of electronics technology, various electronic apparatuses such as personal computers (PCs), mobile phones, personal digital assistants (PDAs), digital cameras, and notebooks have now become commonplace. In addition to enjoying the functions and features of an electronic apparatus, consumers also expect the electronic apparatus to have an aesthetically attractive appearance. The enclosure of the electronic apparatus preferably has anti-corrosion, anti-dust, and anti-fingerprint characteristics.

Referring to FIG. 3, an anti-fingerprint coating construction for stainless steel is reported in an article by Akira Matsuda, entitled “Chromate Electrogalvanized Steel Sheet ‘RIVER ZINC F’ with Anti-fingerprint Property and High Corrosion Resistance” (Kawasaki Steel Technical Report No. 12, July 1985). The anti-fingerprint coating construction includes a zinc layer 12 electrogalvanized on a surface of a stainless steel substrate 11, a chromate layer 13, and a resin layer 14. The chromate layer 13 and the resin layer 14 are formed on the zinc layer 12 in sequence. A thickness h1 of the zinc layer 12 is about 3 μm. A thickness h2 of the chromate layer 13 is in the range from about 0.01 μm to 0.1 μm. A thickness h3 of the resin layer 14 is in the range from about 0.3 μm to 1.0 μm. Thus, high anti-corrosion and anti-fingerprint characteristics for the stainless steel substrate 11 are obtained.

However, the chromate material can cause environmental pollution. In order to avoid environmental pollution, a variety of substitutes for the chromate material have been developed. For example, phosphate is utilized to substitute for the chromate. However, a metal surface treated with the phosphate material is liable to crack. The anti-corrosion properties of the surface may diminish after a long period of usage.

U.S. Pat. No. 6,736,908, issued on May 18, 2004, discloses a metal surface treating composition. The composition includes a specific type of dissolved and/or dispersed organic resin, a dissolved vanadium compound, and a dissolved metal compound that contains at least one of the metals Zr, Ti, Mo, W, Mn, and Ce. The composition can provide metal surfaces with superior anti-corrosion, alkali resistance, and anti-fingerprint properties. The composition contains no chromium, therefore environmental pollution problems are avoided. However, the organic resin is highly specific and therefore difficult to produce. In addition, the composition is only used for application to a metal surface. Nowadays, many or most electronic apparatus enclosures are made of nonmetal material.

What is needed, therefore, is an anti-fingerprint coating construction which is environmental friendly and suitable for application to both a metal surface and a nonmetal surface of an electronic device.

### SUMMARY

An anti-fingerprint coating construction for application to a surface of a substrate is provided. A preferred embodiment of the anti-fingerprint coating construction includes a layer formed of a material selected from the group consisting of a hydrophobic nano-composite material, an oleophobic nano-composite material, and a super-amphiphobic nano-composite material.

Compared with conventional anti-fingerprint coating constructions, the anti-fingerprint coating constructions of the preferred embodiments have the following advantages. Firstly, when the anti-fingerprint coating construction is employed on a metal surface or a nonmetal surface, sweat or/and grease on fingers of a user is not liable to be adhered to the surface. Therefore a fingerprint of the user is prevented from being imprinted on the surface, and the surface can remain clean and aesthetically pleasing. Secondly, because the anti-fingerprint coating construction is easy to clean, the anti-fingerprint coating construction has good anti-corrosion and antibacterial properties. Thirdly, the anti-fingerprint coating construction contains no chromium, and therefore does not need to be processed by an acid or alkali solution. This makes the anti-fingerprint coating construction environmentally friendly.

Other advantages and novel features will become more apparent from the following detailed description of preferred embodiments when taken in conjunction with the accompanying drawings, in which:

### BRIEF DESCRIPTION OF THE DRAWINGS

FIG. 1 is a schematic, side view of an anti-fingerprint coating construction for application to a nonmetal substrate in accordance with a first preferred embodiment of the present invention;

FIG. 2 is a schematic, side view of an anti-fingerprint coating construction for application to a stainless steel substrate in accordance with a second preferred embodiment of the present invention; and

FIG. 3 is a schematic, side view of a conventional anti-fingerprint coating construction for application to a stainless steel substrate.

### DETAILED DESCRIPTION OF PREFERRED EMBODIMENTS

Reference will now be made to the drawings to describe preferred embodiments of the present invention in detail.

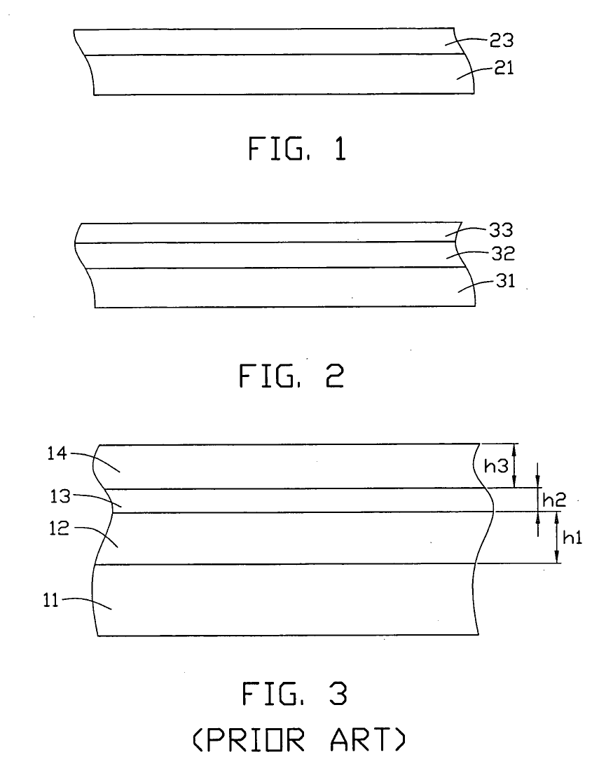

Referring to FIG. 1, an anti-fingerprint coating construction 23 for a nonmetal substrate 21 in accordance with a first preferred embodiment of the present invention is shown. The anti-fingerprint coating construction 23 includes a layer formed of a material selected from the group consisting of a hydrophobic nano-composite material, an oleophobic nano-composite material, and a super-amphiphobic nano-composite material. A thickness of the anti-fingerprint coating construction 23 is less than 1 μm, and is preferably in the range from about 0.1 μm to 0.5 μm. A nonmetal substrate 21 can be made of a material selected from the group consisting of a plastic material, glass, a ceramic material, and a polymer. The nonmetal substrate 21 may be part of an enclosure or an outer housing of, for example, a mobile phone, a PC, a digital camera, a PDA, etc.

The hydrophobic nano-composite material can be selected from the group consisting of a polymer nano-fiber, an organic silicon based nano-material, and a super-hydrophobic material. The polymer nano-fiber can be selected from the group consisting of a polyacrylonitrile, a polyolefin, a polyester, a polyamide, and polyvinyl alcohol. The organic silicon based nano-material can be selected from the group consisting of a fluorosilane, a thionic silane, and silicone. The super-hydrophobic material advantageously includes fluorine-free super-hydrophobic nano-fibers. The layer of super-amphiphobic nano-composite material is formed of a layer of nano-composite material that has a super-hydrophobicity and super-oleophobicity. The oleophobic nano-composite material can be formed of nano-calcium carbonate. The layer of super-amphiphobic nano-composite material may include a super-amphiphobic carbon nanotube array.

The polymer nano-fiber and the organic silicon based nano-material function same as conventional hydrophobic materials. As known in the art, the magnitude of the adhesive force acting between water and a material depends on the surface energy of such material. However, the surface energy of a hydrophobic material is relatively low. Thus, in the case of the hydrophobic material, only a tiny adhesive force is generated between the water and the hydrophobic material. The polymer nano-fiber and the organic silicon based nano-material advantageously have excellent hydrophobic properties. In addition, due to the contact angle between the hydrophobic material and the water being inversely proportional to the adhesive force, the contact angle between the hydrophobic material and the water is therefore relatively large. The surface energy of the super-hydrophobic material is lower than that of the polymer nano-fiber and the organic silicon based nano-material, therefore the hydrophobic characteristic of the super-hydrophobic material is much better than that of the polymer nano-fiber and the organic silicon based nano-material. In particular, the contact angle between the super-hydrophobic material and the water is advantageously larger than 150 degrees.

The super-amphiphobic nano-composite material has a concave surface that can adsorb and stabilize an ambient gas therearound, thereby forming a kind of membrane layer of gas. Because of the gas membrane, water and oil cannot contact the surface of the super-amphiphobic nano-composite material.

Referring to FIG. 2, an anti-fingerprint coating construction 33 for a stainless steel substrate 31 in accordance with a second preferred embodiment of the present invention is shown. A zinc layer 32 is firstly electrogalvanized on a surface of the stainless steel substrate 31, for protecting the stainless steel substrate 31 from being rusted and thereby prolonging its service lifetime. The anti-fingerprint coating construction 33 of the second embodiment has a configuration similar to that of the first embodiment detailed above.

Compared with conventional anti-fingerprint coating constructions, the anti-fingerprint coating constructions of the preferred embodiments have the following advantages. Firstly, when the anti-fingerprint coating construction is employed on a metal surface or a nonmetal surface, sweat or/and grease on fingers of a user is not liable to be adhered to the surface. Therefore a fingerprint of the user is prevented from being imprinted on the surface, and the surface can remain clean and aesthetically pleasing. Secondly, because the anti-fingerprint coating construction is easy to clean, the anti-fingerprint coating construction has good anti-corrosion and antibacterial properties. Thirdly, the anti-fingerprint coating construction contains no chromium, and therefore does not need to be processed by an acid or alkali solution. This makes the anti-fingerprint coating construction environmentally friendly.

It is to be understood that the above-described embodiments are intended to illustrate rather than limit the invention. Variations may be made to the embodiments without departing from the spirit of the invention as claimed. The above-described embodiments are intended to illustrate the scope of the invention and not restrict the scope of the invention.

What is claimed is:

1. An anti-fingerprint coating construction for application to a surface of a substrate, the anti-fingerprint coating construction comprising a layer formed of a material selected from the group consisting of a hydrophobic nano-composite material, an oleophobic nano-composite material, and a super-amphiphobic nano-composite material.

2. The anti-fingerprint coating construction as claimed in claim 1, wherein the hydrophobic nano-composite material is selected from the group consisting of polymer nano-fibers, an organic silicon based nano-material, and a super-hydrophobic material.

3. The anti-fingerprint coating construction as claimed in claim 2, wherein the polymer nano-fiber is comprised of a material selected from the group consisting of a polyacrylonitrile, a polyolefin, a polyester, a polyamide, and polyvinyl alcohol.

4. The anti-fingerprint coating construction as claimed in claim 2, wherein the organic silicon based nano-material is comprised of a material selected from the group consisting of a fluorosilane, a thionic silane, and silicone.

5. The anti-fingerprint coating construction as claimed in claim 2, wherein the super-hydrophobic material comprises fluorine-free super-hydrophobic nano-fibers.

6. The anti-fingerprint coating construction as claimed in claim 1, wherein the oleophobic nano-composite material comprises nano-calcium carbonate.

7. The anti-fingerprint coating construction as claimed in claim 1, wherein the layer of super-amphiphobic nano-composite material comprises a super-amphiphobic carbon nanotube array.

8. The anti-fingerprint coating construction as claimed in claim 1, wherein a thickness of the anti-fingerprint coating construction is less than 1 μm.

9. The anti-fingerprint coating construction as claimed in claim 8, wherein the thickness of the anti-fingerprint coating construction is in the range from 0.1 μm to 0.5 μm.

10. The anti-fingerprint coating construction as claimed in claim 1, wherein the substrate is a metal substrate or a nonmetal substrate.

11. A method for forming an anti-fingerprint coating onto a surface of a substrate, comprising the steps of:
selecting coating material applicable to a surface of a substrate from a group consisting of a hydrophobic nano-composite material, an oleophobic nano-composite material, and a super-amphiphobic nano-composite material;
treating said surface of said substrate to be ready for said selected coating material; and
applying said selected coating material onto said surface of said substrate so as to form an anti-fingerprint coating thereon.
